(19) United States
(12) Patent Application Publication
(10) Pub. No.: US 2003/0207634 A1
(43) Pub. Date: Nov. 6, 2003

(54) Composite structure made of urethane and woven backing materials

(76) Inventor: Ulrich B. Holeschovsky, Sewickley, PA (US)

Correspondence Address: BAYER POLYMERS LLC, 100 BAYER ROAD, PITTSBURGH, PA, 15205, US

(21) Appl. No.: 10/138,994

(22) Filed: May 3, 2002

(51) Int. Cl. B32B 3/00; B32B 5/02; B32B 9/00; B32B 3/12; B32B 3/26; D03D 15/00; D03D 25/00; D03D 13/00; B32B 5/08; B32B 27/02; B32B 5/18; B32B 5/24; B32B 9/04; B32B 27/00; B32B 27/40; B32B 19/04; B32B 23/04; B32B 13/04

(52) U.S. Cl. 442/221; 442/203; 442/220; 442/181; 442/59; 428/158; 428/304.4; 428/322.7; 428/411.1; 428/425.1; 428/454; 428/445

(57) ABSTRACT

The present invention relates to composite structures comprising an open weave, natural or synthetic fabric or backing having fibers and a urethane froth foam, wherein the fibers of the fabric or backing are at least partially penetrated and/or embedded by the urethane froth. This invention also relates to a process for the production of a composite structure comprising A) applying a reactive urethane froth to an open weave, natural or synthetic fabric or secondary backing having fibers, B) passing the fabric or backing coated with the reactive urethane froth under a doctoring device such that the reactive urethane froth at least partially penetrates and/or embeds the fibers of the fabric or backing, and C) curing the reactive urethane froth.

### BACKGROUND OF THE INVENTION

The present invention relates to a composite structures comprising an open-weave, synthetic or natural fabric or backing having fibers and a urethane froth foam, wherein the fibers of the fabric or backing are at least partially penetrated and/or embedded by the urethane froth prior to curing to form a urethane froth foam. This invention also relates to a process for the production of a composite structure comprising A) applying a reactive urethane froth to a fabric or backing having fibers, B) passing the fabric or backing coated with the reactive urethane froth under a doctoring device such that the reactive urethane froth at least partially penetrates and/or embeds the fibers of the fabric backing, and C) curing the reactive urethane froth.

Polyurethane foam backed substrates and a process for their production are described in, for example, U.S. Pat. Nos. 4,483,894 and 5,104,693. A polyurethane carpet-backing process using soft segment prepolymers of diphenylmethane diisocyanate is disclosed by U.S. Pat. No. 5,104,693.

The process of U.S. Pat. No. 4,483,894 comprises applying a frothed polyurethane forming composition to the back of a substrate, wherein the polyurethane forming composition comprises a high MW polyether polyol, a low MW polyether polyol, a polyiso(thio)cyanate, an inorganic filler, a catalyst, and a silicone surfactant having a MW of less than 30,000. Suitable substrates to which the frothed compositions can be applied include carpet (particularly tufted carpet), paper, synthetic and natural textile fabrics such as, for example, nylon, polyester, acrylic, cotton, wool, etc. When a tufted carpet is the substrate, the primary backing can be prepared from jute, polypropylene, nylon, polyesters, polyacrylates, etc.

Secondary backings and/or a process for producing composites from secondary backings and urethane froths are not disclosed by this patent.

Flooring applications such as, for example, laminates, ceramic tiles, etc. require an underlay to provide sound absorption, cushioning, etc. The composite structures of the present invention are suitable for use as underlays for these and other flooring applications.

Underlays suitable for ceramic tile applications are required to meet more demanding physical properties, including physical strength and internal adhesion, than any underlays or membrane for laminate or hardwood floors. The main purpose of a ceramic tile underlay or membrane is concealed crack isolation and waterproofing. Additionally, some underlay and membranes may serve as sound insulators. There are numerous testing requirements that need to be satisfied according to criteria established by the Ceramic Tile Institute (CTI). These fall into three main groups of tests.

The first group comprises direct bond tests that concern complete ceramic tile installations. They are a Bond Shear Strength Test (ASTM C-482), which measures lateral psi at which an installation loses bond under wet and dry conditions with a CTI minimum standard of 50 psi. A Tensile Strength Test (CTI/SE 5763) which measures psi pull strength at which installation loses bond under dry and wet conditions with a CTI minimum standard of 50 psi, and a total system performance test, the Robinson Floor Test (ASTM 627(mod)) which tests for integrity of total installation, i.e. no tile cracking/chipping or grout deterioration after successive cycles of increased load/stress over split substrate. This test includes hydrostatic testing with 2″ head of water performed at end of cycles. The minimum number of completed cycles before failing is three.

The second group of tests are performed only with the underlay or membrane. These include a number of waterproof tests that require that the underlay or membrane shows no water penetration at the end of the various testing periods. These tests include a hydrostatic test (FHA 4900.1 Sect. 615-5) which measures the integrity of the membrane or underlay after being subjected to 2 ft. head of water for 48 hours, an indentation resistance test (FHQ 4900.1) which tests if the membrane or underlay is chemically resistant to highly alkaline solutions such as soapy water, a puncture resistance test (FHA 4900.1) which involves a 200 g dart with a small ball bearing point being dropped from 3 ft. to simulate dropping of a sharp edged tool onto the underlay or membrane, and a folding resistance test (FHQ 4900.1) which tests the underlay or membrane for cracking in cold weather. Other tests of group II include a fungus and micro-organism resistance test (FHA 4900.1 plus Sect. C or ANSI A1361.1 K-64), a dimensional stability test (ASTM D-1204), seam strength, breaking strength and elongation tests (all ASTM D-751). Finally group II includes a hydrostatic pressure test (ASTM D-751, A-1) which simulates a water pipe burst by measuring the effect of a sudden burst of high water pressure on the underlay or membrane. Group III comprises optional tests not required by CTI.

Conventional underlays are prepared by applying the reactive urethane froth on a substrate. Suitable substrates include paper, synthetic and natural textile fabrics such as, for example, nylon, polyester, acrylic, cotton, wool, etc. Primary backings commercially used for tufting are also suitable substrates. Primary backings are typically made from polypropylene, nylon, polyesters, polyacrylates, etc. Any material that is either continuous or whose pores or openings are sufficiently small to retain conventional urethane froth formulations when applied to the substrate and while it is cured in the oven is a suitable substrate for a conventional underlay. Because the bond between the polyurethane and the substrate is typically not very strong, the substrate can be easily delaminated causing these conventional underlays to fail several of the CTI prescribed tests, especially those tests of Group I. In particular, delamination will cause failure of the Bond Shear Strength test and the Robinson Floor test.

Flooring underlays are known and described in, for example, U.S. Pat. Nos. 6,189,279 and 6,213,252. The underlays of U.S. Pat. No. 6,189,279 are described as floating floor underlays comprising an open celled foam sheet consisting of latex, polyvinylchloride or polyurethane, and a moisture impermeable polymer film. These moisture impermeable polymer films have a water transmission value of less than 0.007 oz/yd²/hr (239 mg/m²/hr). The underlays of U.S. Pat. No. 6,213,252 are characterized as sound absorbing, and are suitable for commercial, residential or industrial underlays for flooring structures. These sound-absorbing substrates are made of resilient materials having bottom and top surfaces and side edges wherein the bottom surface has cavities such that only a portion of the bottom surface contacts the subfloor. Recycled rubber, preferably from recycled tires, is a preferred resilient material.

U.S. Pat. No. 4,710,415 discloses reinforced foam anti-fatigue floor tile modules and a method of making these. These floor tile modules comprise (a) a resilient, substantially closed cell vinyl foam layer having a density of at least about 20 lbs./³, and one or more embossed, anti-friction or design patterns thereon, and (b) a reinforcing fibrous sheet material within the foam layer and positioned between 55 to 65% of the depth of the foam layer from the non-embossed surface to provide a dimensionally stable floor module. The fibrous reinforcing sheet described in the '415 patent is used to produce rigid floor modules. The present invention is not rigid, can be rolled and cut with a regular carpet knife.

Underlays for flooring are also disclosed in U.S. Pat. Nos. 5,501,895 and 5,578,363. U.S. Pat. No. 5,501,895 describes floor covering systems comprising an underlayment, an adhesive and a resilient flooring sheet. The underlayment is attached to the flooring sheet by the adhesive and comprises a fiber layer about 10 mils in thickness and a foamed polymeric layer. The floor covering underlayments of U.S. Pat. No. 5,578,363 comprise a fiber layer, a first layer of unfoamed polymeric material, and a second polymer layer, with the fiber layer being interposed between the polymeric layers such that these interpenetrate a portion of the fiber layer.

Aqueous polyurethane dispersions that can be mechanically frothed to yield a foam with good resiliency are disclosed in U.S. Pat. No. 6,271,276. These foams are suitable for cushioned flooring applications including, for example, cushion broadloom carpet tiles, carpet underlay, vinyl flooring, etc. Curing of these polyurethane dispersion occurs by evaporating water and subsequently agglomeration of the particles. Dispersions of U.S. Pat. No. 6,271,276 do not contain reactive NCO and/or OH groups such as are present in the polyurethane froth formulations of the present invention.

Face-up coating of carpeting when using a polyurethane adhesive is now possible as described in U.S. Pat. No. 6,264,775. These polyurethane adhesives comprise a non-Newtonian thickener, which allows carpet manufacturing lines using polyurethane adhesives to be run “face-up” as practiced with conventional latex adhesives carpet manufacturing equipment.

The present invention provides a composite structure which is a suitable underlay for all flooring applications, including ceramic tiles, and exhibits good physical strength and cohesion. The present invention can be used as a concealed crack isolation and/or waterproof membrane of ceramic and marble tile, terrazo and brick, for new construction, remodeling or repair, and in residential or commercial facilities including in kitchens, restaurants, resident entries, steam rooms, radiant heated flooring, shopping malls, etc. Additionally, the present invention also serves as a sound absorbing layer.

### SUMMARY OF THE INVENTION

This invention relates to a composite structure comprising (A) an open weave, natural or synthetic fabric or backing having fibers, and (B) a urethane froth foam comprising (1) at least one polyisocyanate component, (2) at least one isocyanate-reactive component, (3) at least one non-Newtonian thickener, (4) at least one catalyst, and, optionally, (5) one or more fillers; wherein the fibers of the fabric or backing are at least partially penetrated and/or embedded by the urethane.

Another aspect of the present invention is a process for the production of a composite structure (preferably an underlay). This process comprises A) applying a reactive urethane froth to an open weave, natural or synthetic fabric or backing having fibers, B) passing the fabric or backing that is coated with urethane froth under a doctoring device such that the reactive urethane froth at least partially penetrates and/or embeds the fibers of the fabric or backing, and C) curing the reactive urethane froth, thereby forming a urethane foam adhered to the fabric or backing. Suitable reactive urethane froths comprise (1) at least one polyisocyanate component, (2) at least one isocyanate-reactive component, (3) at least one non-Newtonian thickener, (4) at least one catalyst, and, optionally, (5) one or more fillers.

### BRIEF DESCRIPTION OF THE DRAWINGS

The FIGURE illustrates a cross-sectional view of a composite structure, which is representative of the present invention.

### DETAILED DESCRIPTION OF THE INVENTION

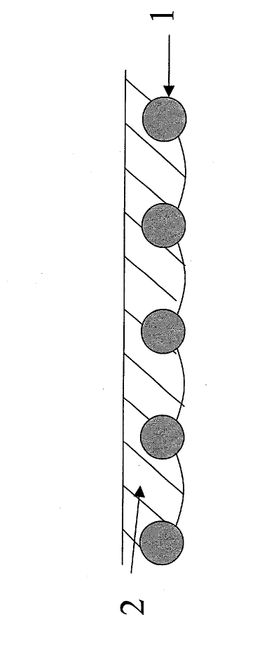

Suitable open weave, natural or synthetic fabrics or backings having fibers for the composite structures of the present invention include, for example, those fabrics or backings which are preferably woven and have sufficient openings to allow the live urethane froth to be pushed into the weave by a doctoring device, resulting in a composite structure. One such composite structure is shown in FIG. 1, described in detail below. The benefit of such a composite structure is that it combines the strength characteristics of the secondary backing in the horizontal direction with the elastic, sound absorbing and cushioning properties of the urethane in the vertical direction.

A preferred open weave backing comprises any of the known secondary backings used in the carpeting industry. Of the known secondary backings, ACTIONBAC which is commercially available from Amoco, is an particularly preferred open weave secondary backing for the present invention. In the conventional use of secondary backings such as ACTIONBAC, the secondary backing is laminated to the back of the carpet or greige good to provide dimensional stability and strength for stretch-in installations.

The reactive urethane froth may be applied to the open weave, natural or synthetic fabric or backing by a supply hose or other conventional methods, including dipping, spraying, etc. The frothing of the reactive urethane mixture may be accomplished by using a frothing apparatus, for example an Oakes or Firestone froth head.

The reactive mixtures are typically frothed to various degrees, depending on the desired density. Frothing of the formulations described above can be accomplished as described in, for example, U.S. Pat. No. 5,604,267, the disclosure of which is herein incorporated by reference. Frothing may also be accomplished in the conventional manner by introducing the reactive ingredients together with a substantially inert gas such as air, nitrogen, argon, carbon dioxide, or the like, into a froth mixer such as an Oakes or Firestone mixer. The frothed mixtures are generally gauged with a doctoring device such as, for example, a doctor blade or roller, or the like, to the desired thickness. Frothed mixtures may also include a volatile or reactive blowing agent, most preferably water, in addition to being mechanically frothed, to produce a foam with a relatively low density.

The reactive urethane froths comprise (1) one or more di- or polyisocyanates (i.e. an A-side), and (2) an isocyanate-reactive component (i.e. a B-side) which comprises one or more polyols, generally polyols having nominal functionalities of from 2 to 8, and/or one or more low molecular weight chain extenders and/or crosslinkers, and (3) one or more non-Newtonian thickeners, (4) one or more catalysts, optionally, (5) fillers, and other optional components such as, for example, surfactants, plasticizers, pigments, and other well known polyurethane additives. Although generally fillers are employed, fillers are optional in the present invention. Preferred reactive polyurethane systems to be used in the present invention are described in detail in, for example, U.S. Pat. Nos. 5,462,766, 5,558,917, 5,723,194, 6,171,678, 6,264,775 and 6,328,833, the disclosures of which are herein incorporated by reference.

Some examples of suitable di- and polyisocyanates to be used as component (1) of the reactive urethane froths include toluene diisocyanate, (TDI) and methylene diphenylene diioscyanate (MDI) and mixtures thereof. MDI need not be used in the form of the pure or nearly pure 4,4′-isomer. Modified isocyanates such as, for example, urethane- and carbodiimide-modified isocyanates, particularly the former, may be used. Polymeric and crude MDI containing tri- and higher functional isocyanates may be used as well. Isocyanate-terminated prepolymers and quasi-prepoymers are also useful. It is preferable that the isocyanate index be maintained between 80 and 130, with the indexes in the range of 95 to 110 being more preferred.

The polyols to be used as component (2) in the reactive urethane froths of the present invention are well known and may have average nominal functionalities ranging from about 2 to about 8, preferably in the range of 2 to 3. The polyols may be polytetramethylene ether glycols (PTMEG), hydroxyl-functional polyester polyols, or preferably polyoxypropylene polyols which may be homopolymeric or may be a copolymer containing other copolymerizable monomers such as ethylene oxide, butylene oxide, oxetane, etc. Polyoxyalkylene polyols may be prepared by base catalyzed oxyalkylation of suitable hydric initiator molecules, and may advantageously be low or ultra-low unsaturation polyols having levels of intrinsic unsaturation less than about 0.015 meq/g, preferably lower than 0.010 meq/g, and most preferably with maximum unsaturation in the range of 0.002 to 0.007 meq/g. The polyols may have equivalent weights of from about 300 Da to about 10,000 Da, preferably 500 Da to 4000 Da, and most preferably in the range of 1000 Da to 2000 Da. The polyoxyalkylene copolymer polyols may be block, random, block-random, or any other configuration. In one-shot systems, polyols with high primary hydroxyl content are especially preferred.

Isocyanate-terminated prepolymers useful herein maybe prepared by conventional methodology, preferably at somewhat elevated temperature. The free isocyanate content may range from about 1 weight percent or below to about 35 weight percent or higher, more preferably 2 weight percent to about 30 weight percent, yet more preferably 6 weight percent to about 25 weight percent, and most preferably in the range of 8 weight percent to about 20 weight percent. The polyol component used to prepare the prepolymers may be one of the polyols previously described, or a lower molecular weight glycol or oligomeric glycol or polyol.

Suitable catalysts to be used as component (4) in the present invention include, for example, tertiary amines and organometallic compounds, and mixtures thereof. For example, suitable catalysts include di-n-butyl tin bis(mercaptoacetic acid isooctyl ester), dimethyltin dilaurate, dibutyltin dilaurate, dibutyltin sulfide, stannous octoate, lead octoate, metal acetylacetonates, bismuth carboxylates, triethylenediamine, N-methyl morpholine, and mixtures thereof. Both an amine type catalyst and an organometallic catalyst can be employed in combination. An amount of catalyst is advantageously employed such that a relatively rapid cure to a tack-free state at elevated temperature, i.e. above 100° C., is combined with a relatively low reactivity at lower temperatures, i.e. below 50° C., thus allowing sufficient puddle life time, i.e. application of the live froth in the puddle without premature reaction and setting up of the puddle.

Suitable fillers to be used as component (5) in the present invention, when a filler is used, include, for example, the mineral fillers conventionally used including, for example, ground limestone, dolomite, alumina trihydrate, etc. The fillers are of relatively large particle size, for example, commonly in the range of 15 μm to 100 μm, and thus have low specific (BET) surface area. The surface area of such fillers is, in general, 2 less than 5 m²/g. Amounts of filler vary quite widely, but amounts of from 50 parts to 400 parts of filler per 100 parts of isocyanate-reactive components, preferably from 150 parts to 250 parts of filler per 100 parts of isocyanate-reactive components, are typical. It should be noted that these fillers do not cause any substantial non-Newtonian behavior.

The non-Newtonian thickeners, component (3) of the reactive urethane froths, may be any thickener which exhibits a substantial inverse relationship between shear and viscosity. In general, inorganic particulates having BET surface areas greater than about 10 m² g, preferably greater than 40 m²/g, more preferably greater than 100 m²/g, and yet more preferably 200 m²/g or more, are suitable. The thickeners may be hydrophobic or hydrophilic in nature. Examples include precipitated calcium carbonate, finely divided clays, preferably smectite or “layered” clays, and precipitated and “fumed” silicas, i.e., silicas produced by flame pyrolysis processes and the like. Such thickeners are well known and available from numerous sources, including General Electric, Dow Corning Silicones, Wacker-Chemie GmbH and Wacker Silicones Corporation, Rhone-Poulenc, and Degussa, among others. Inorganic thickeners are used in amounts which preferably at least double the resting viscosity as opposed to the viscosity exhibited under a shear rate of 50 sec⁻¹. More preferably, the rest viscosity at 25° C. is more than three times the viscosity at a shear rate of 50 sec⁻¹ or more, and most preferably more than ten times this viscosity.

Since the action of non-Newtonian particulate thickeners is due, at least in part, to surface interactions, the nature of the surface will cause the amount of thickener as well as its overall effect to vary somewhat. However, adjustment of the amount of thickener can be easily accomplished.

Some particular thickeners such as fumed silica have relatively small particle sizes, and are highly efficient non-Newtonian thickeners. For example, Aerosil® 200 or Cabosil-M5®, with average primary particle sizes of 0.012 μm are only required in relatively small amounts. The upper limit (UL) of the fumed silica depends on the amount of filler (i.e. filler level, FL) per 100 parts of the isocyanate-reactive components, as shown in the following equation:

UL=8−(0.02×FL)

This equation applies to filler levels from 0 to 400 parts of filler.

The lower limit (LL) is determined by the following equation:

LL=3−(0.01×FL)

This equation applies to filler levels from 0 to 300 parts of filler.

These equations are only intended to provide general guidelines. The exact amounts of thickener required will depend on the grade of non-Newtonian thickener used.

Precipitated and surface treated calcium carbonate, such as Thixocarb 500 (commercially available from Specialty Minerals Inc., Adams, Mass.), with an average particle size of 0.15 μm, follow similar relationships, however, because of their larger particle size, the required usage levels are approximately 6 times higher than for fumed silica.

In general, inorganic particulate thickeners average particle size must be less than 1 μm, preferably less than 0.3 μm, and most preferably less than 0.1 μm. The usage levels are typically inversely related to the amount of filler used because these thickeners create bridges between the much larger filler particles often via hydrogen bonding among other mechanisms. Hence, filler and thickening agent create a structure in which the filler particles are all connected via bridges. As more filler is present in the mixture, the distance between the filler particles is lowered and thus, less thickener is needed to bridge the gap between filler particles.

Organic thickeners which display non-Newtonian characteristics are also useful. An expedient way to test a particular thickener for its non-Newtonian thickening ability is to add the thickener to a target polyurethane adhesive “B-side” (resin side), and measure its viscosity at different levels of shear. Thickeners which exhibit a substantial inverse relationship between viscosity and shear are non-Newtonian thickeners suitable for the present invention. Candidate thickeners include the various vegetable gums, i.e. carrageenan, tragacanth, acacia, guar, and the like; modified celluloses, e.g., carboxymethylcellulose, carboxypropylcellulose, hydroxymethylcellulose, and the like; polyacrylic acid polymers and copolymers with acrylates and other unsaturated monomers, e.g., the Carbopol® and Acrysol® thickeners; very high molecular weight polyethers, such as high molecular weight polyoxyethylene glycol, and the like. Associative thickeners may be particularly effective. Associative thickeners are molecules which have a hydrophobic or non-polar portion and a hydrophilic, polar, or ionic portion. In solution, the non-polar portions tend to associate with each other, as do the hydrophilic, polar, or ionic portions, forming extraordinarily long “associative” chains and networks. The interactions are easily broken by shear, however, and thus the molecules exhibit decidedly non-Newtonian behavior. Combinations of organic non-Newtonian and inorganic non-Newtonian thickeners may be used as well. Examples of non-Newtonian thickeners may be found in U.S. Pat. Nos. 4,709,099 and 4,649,224, the disclosures of which are herein incorporated by reference. It is possible to tailor the properties of certain of the polyols to serve as non-Newtonian thickeners.

Reference will now be made to one embodiment of the present invention as illustrated in the FIGURE, a cross-sectional view of a composite foam structure. In the FIGURE, the composite foam structure comprises a woven secondary backing 1 having fibers, and a urethane foam 2 which at least partially embeds the fibers of the woven secondary backing 1.

The urethane froth foam formulations suitable for the present invention can also include other optional components. For example, these formulations may include surfactants, frothing agents, blowing agents, water, wetting agents, dispersants, thickeners, fire retardants, pigments, antistatic agents, reinforcing fibers, antioxidants, preservatives, biocides, acid scavengers and the like. Examples of suitable frothing agents include gases and/or mixtures of gases such as, for example, air, carbon dioxide, nitrogen, argon, helium, and the like. While optionally for purposes of the present invention, some components can be highly advantageous for ease of processing and properties of the final product.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all parts and percentages are parts by weight and percentages by weight, respectively.

### EXAMPLES

Two similar polyurethane formulations were tested to illustrate the present invention and advantages associated with it.

The following components were used in the polyurethane formulations.

| | |
|---|---|
| LC 5615: | a catalyst commercially available from Crompton |
| | Corp. |
| L 5614: | a silicone surfactant, commercially available from |
| | Crompton Corp. |
| Aerosil 200: | fumed silica, commercially available from Degussa, |
| Atlantis ® | an isocyanate-reactive blend commercially available |
| Q1000: | from Bayer Corp. |
| Polyol A: | a polyether polyol having a functionality of about 2, an |
| | OH number of about 40 and a molecular weight of |
| | about 2800, prepared by alkoxylating a propylene |
| | glycol starter with propylene oxide (PO) and capping |
| | with 15% by weight of ethylene oxide (EO) |
| DEG: | diethylene glycol |
| Filler: | calcium carbonate |
| Isocyanate A: | a polyisocyanate having an NCO group content of |
| | about 27.5%, commercially available from Bayer |
| | Corp. |

The first seven (7) components set forth in Table 1 below were mixed together to form an isocyanate-reactive B-side. Isocyanate A in Table 1 below was the A-side used to react with this B-side.

TABLE 1

| | Comparative | |
|---|---|---|
| Component | Example 1 | Example 1 |
| Q1000 | 72 | 72 |
| Polyol A | 14 | 14 |
| DEG | 11 | 11 |
| LC-5615 | 1.4 | 1.4 |
| L5614 | 1.5 | 1.5 |
| Aerosil 200 | 0 | 1.6 |
| Filler | 80 | 180 |
| Isocyanate A | 66 | 66 |
| Isocyanate Index | 103 | 103 |
| Substrate | Primary backing | 11 pic ACTIONBAC |
| | | backing |

It is apparent from the formulations presented in Table 1 above that the only difference in the polyurethane formulations is the presence of Aerosil 200, a non-Newtonian thickener, in Example 1.

The B-side components (i.e. Q1000, Polyol A, DEG, LC-5615, L 5614, Aerosil 200 and the filler) of both the comparative example and Example 1 from Table 1 above were mixed in an “in-line blender” as described in U.S. Pat. No. 5,604,267, the disclosure of which is herein incorporated by reference. The A-side and B-side for each example were metered into a Firestone pin mixer. Dry air was metered to produce a final foam density ranging from 24 to 28 pcf. In Example 1, the frothed mixture was continuously applied on top of an 11 pic ACTIONBAC secondary backing that was moved by tenters at a rate of about 3 ft./min. The froth was doctored with a doctor blade to produce an embedded structure as shown in FIG. 1, with a total thickness of about 2.2 to about 2.6 mm. The frothed mixture in Comparative Example 1 was applied to a regular woven primary backing as it is used customarily in tufting greige goods. The total thickness was the same as in Example 1. Both Examples were passed through a curing oven with an approximate residence time in the oven of about 4 mins. The temperature at the oven exit was about 150° C.

Results:

The presence of the non-Newtonian thickener in the polyurethane froth formulation of Example 1 permitted it to be applied to an open weave secondary backing such as ACTIONBAC, without dripping through the openings prior to curing of the froth. This example permitted the polyurethane froth formulation to embed and/or penetrate the fibers of the secondary backing.

It is not possible to conduct a comparative example on ACTIONBAC for the present invention since in the absence of the non-Newtonian thickener, the polyurethane formulation would allow the polyurethane to flow through the open-weave secondary backing, especially as it is heated up in the curing oven and drip onto the hot surfaces of the curing oven. Therefore, in order to present a reasonable comparative example to Example 1 above, a comparison example was conducted using a polyurethane froth formulation which is free of non-Newtonian thickeners, which was applied to a primary backing. As one of ordinary skill in the art knows and understands, primary backings are different than secondary backings in that the weave is substantially closed instead of being open.

In Comparative Example 1, the backing could be easily pulled and separated from the polyurethane foam. Therefore, it is unsuitable as a ceramic tile underlay because it can not pass either the bond shear strength nor the Robinson Flooring test since the whole ceramic tile will become loose with the urethane attached while the primary backing will remain attached to the subfloor. In Example 1 it is not possible to delaminate the backing from the urethane foam without destroying the urethane foam. A sample of Example 1 was tested and passed both the Bond Shear Strength test and the Robinson Floor test.

Table 2 below compares the results for Comparative Example 1 and Example 1 for a variety of tests showing a dramatic improvement in the tensile strength and tear strength. The primary backing of Comparative Example 1 was delaminated before testing.

TABLE 2

| | Comparative | |
|---|---|---|
| | Example 1 | Example 1 |
| Density (pcf)³ | 26.9 | 24.2 |
| Tensile Strength (psi)¹ | 159 | 850 |
| Elongation(%)¹ | 66.7 | 31.3 |
| Split Tear Die C (lbs/in)² | 22.0 | 134 |

¹ASTM D3574 or ASTM D412, die A
²ASTM D624, die C
³weight/volume as in D3574

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composite structure comprising:
(A) an open weave, natural or synthetic fabric or backing having fibers, and
(B) a urethane froth foam comprising:
(1) at least one polyisocyanate component,
(2) at least one isocyanate-reactive component,
(3) at least one non-Newtonian thickener, and
(4) at least one catalyst;
wherein the fibers of the fabric or backing are at least partially penetrated and/or embedded by the urethane froth.

2. The composite of claim 1, wherein (A) said open weave, natural or synthetic fabric or backing having fibers comprises a secondary backing.

3. The composite of claim 2, wherein (A) said secondary backing comprises an Actionbac backing.

4. The composite of claim 1, wherein (B) said urethane froth additionally comprises (5) at least one filler.

5. The composite of claim 1, wherein (B)(2) said isocyanate-reactive component of the urethane froth comprises one or more polyoxyalkylene polyols having an intrinsic unsaturation of less than about 0.015 meq/g.

6. The composite of claim 1, wherein (B)(3) said non-Newtonian thickener is selected from the group consisting of precipitated calcium carbonate, finely divided clay, precipitated silica, fumed silica, vegetable gum, modified cellulose, polyacrylic acid polymers, copolymers with acrylates and other unsaturated monomers, and mixtures thereof.

7. A process for the production of a composite structure comprising:
A) applying a reactive urethane froth to an open weave, natural or synthetic fabric or backing having fibers, wherein the reactive urethane froth comprises:
(1) at least one polyisocyanate component,
(2) at least one isocyanate-reactive component,
(3) at least one non-Newtonian thickener, and
(4) at least one catalyst;
B) passing the fabric or backing coated with the reactive urethane froth under a doctoring device such that the urethane froth at least partially penetrates and/or embeds the fibers of the fabric or backing; and
C) curing the urethane froth.

8. The process of claim 7, wherein (A) said open weave, natural or synthetic fabric or backing having fibers comprises a secondary backing.

9. The composite of claim 8, wherein (A) said secondary backing comprises an Actionbac backing.

10. The composite of claim 7, wherein (B) said urethane froth additionally comprises (5) at least one filler.

11. The composite of claim 7, wherein (B)(2) said isocyanate-reactive component of the urethane froth comprises one or more polyoxyalkylene polyols having an intrinsic unsaturation of less than about 0.015 meq/g.

12. The composite of claim 7, wherein (B)(3) said non-Newtonian thickener is selected from the group consisting of precipitated calcium carbonate, finely divided clay, precipitated silica, fumed silica, vegetable gum, modified cellulose, polyacrylic acid polymers, copolymers with acrylates and other unsaturated monomers, and mixtures thereof.
